(19) United States
(12) Patent Application Publication
(10) Pub. No.: US 2024/0304183 A1
(43) Pub. Date: Sep. 12, 2024

(54) Voice Recognition for Voice to Text Generated Typeahead In Suggested Application

(71) Applicant: International Business Machines Corporation, Armonk, NY (US)

(72) Inventors: Jacob Ryan Jepperson, St. Paul, MN (US); Logan Bailey, Atlanta, GA (US); Melanie Dauber, Oceanside, NY (US); Zachary A. Silverstein, Georgetown, TX (US); Jeremy R. Fox, Georgetown, TX (US)

(21) Appl. No.: 18/118,516

(22) Filed: Mar. 7, 2023

(51) Int. Cl. G10L 15/18; G06F 16/35; G10L 15/16

(52) U.S. Cl. CPC G10L 15/1815; G06F 16/35; G10L 15/16

(57) ABSTRACT

Techniques for providing voice to text generated typeahead suggestions for lists of items from voice data are provided. In one aspect, a method for providing typeahead includes: identifying lists of items captured as text from voice data on a Voice Over Internet Protocol connection using voice recognition and natural language processing; and storing the lists of items in memory thereby enabling the typeahead of the lists of items on one or more electronic devices. Further, a suggested application can be provided, and the lists of items are then autocompleted on the one or more electronic devices in the suggested application.

### FIELD OF THE INVENTION

The present invention relates to voice recognition-based technology, and more particularly, to techniques for providing voice to text generated typeahead suggestions for lists of items from voice data in suggested applications using voice recognition.

### BACKGROUND OF THE INVENTION

Web-based audio/video conference call applications facilitate collaboration amongst parties irrespective of their physical location. During a collaborative session, participants often exchange useful information which needs to be retained for later use. For instance, this information can include lists of items such as addresses, telephone numbers, etc. Participants can simply jot down the information during the collaborative session, and type it again when needed.

Doing so, however, diverts the participants' attention away from the speaker. There is also the risk that the process of later reproducing this information can introduce errors. Further, when the user goes back to type in the information, it can be a tedious task to constantly go back and forth with one's notes to verify each item on the list. For instance, when subsequently entering a list of items into the form fields of an application, such as an address in a web-based mapping service, one must often go back and forth inquiring whether any item of information was missed in the transcription.

Therefore, techniques that automate the process for retaining lists of items from a collaborative session, and intelligently leveraging this information for future use would be desirable.

### SUMMARY OF THE INVENTION

The present invention provides techniques for providing voice to text generated typeahead suggestions for lists of items from voice data in suggested applications using voice recognition. In one aspect of the invention, a method for providing typeahead is provided. The method includes: identifying lists of items captured as text from voice data on a Voice Over Internet Protocol connection using voice recognition and natural language processing; and storing the lists of items in memory thereby enabling the typeahead of the lists of items on one or more electronic devices.

For instance, the lists of items can be retrieved from the memory, and the lists of items autocompleted on the one or more electronic devices whenever items from the lists of items are being inputted into the one or more electronic devices (e.g., whenever multiple consecutive characters are being inputted that are contained within strings located in the memory). Further, a suggested application can be provided, and the lists of items autocompleted on the one or more electronic devices in the suggested application.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary computing environment according to an embodiment of the present invention;

FIG. 2 is a diagram illustrating an exemplary system for providing voice to text generated typeahead according to an embodiment of the present invention;

FIG. 3 is a diagram illustrating an exemplary methodology for providing typeahead using the system of FIG. 2 according to an embodiment of the present invention;

FIG. 4 is a diagram illustrating an exemplary methodology for autocompleting a list of items on a connected device in a suggested application according to an embodiment of the present invention;

FIG. 5 is a diagram illustrating an exemplary implementation of the present techniques according to an embodiment of the present invention; and

FIG. 6 is a diagram illustrating an exemplary neural network according to an embodiment of the present invention.

### DETAILED DESCRIPTION OF PREFERRED EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

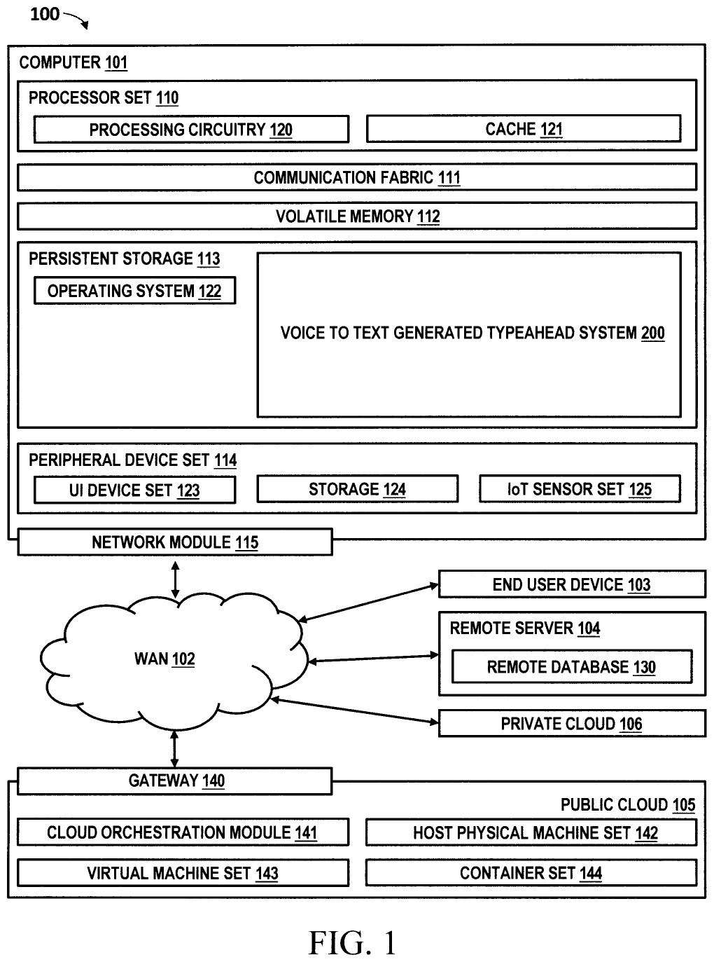

Referring to FIG. 1, computing environment 100 contains an example of an environment for the execution of at least some of the computer code involved in performing the inventive methods, such as system 200 for providing voice to text generated typeahead. In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in system 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As provided above, the exchange of information during conference calls or other web-based collaborative sessions typically involves individual participants jotting down the information from the speaker. Doing so, however, can be tedious, especially when the information includes lists of items that must be precisely recorded for later use such as addresses, telephone numbers, etc. Furthermore, diverting one's attention away from the speaker to write down a list of items can cause a participant to miss out on other pertinent information. There is also the risk that errors are introduced during transcription of the list. Later, when the participant goes back to type in the information, there is the equally tedious task of verifying each item on the list.

Take for instance a scenario where the speaker on a web-based conference call is reciting an address. Traditionally, the participants to the call would individually record the address on their end, such as writing it down on a notepad or using a note-taking application. Later, when any of the participants wants to use the address (e.g., to type or otherwise input it into a web-based mapping service), they have to go back and forth with their notes to ensure that the correct address information is properly entered into each respective field, i.e., street, city, state, zip code, etc.

Advantageously, the present techniques provide an automated system 200 and process (see below) for actively capturing such lists of items from the speaker as text data using voice recognition, and instantiating that text data in memory for generating typeahead suggestions. The term “typeahead” as used herein generally refers to a prediction tool that provides suggestions for users typing data into the fields of a computer-based form or document. Typeahead may also be referred to herein as ‘autocomplete’ or ‘autosuggest.’ Thus, the terms ‘typeahead,’ “autocomplete” and ‘autosuggest’ may be used interchangeably herein when referring to a computer-based feature that auto-populates text in an application or other field. For instance, if a user is typing a query into a search engine, a typeahead provision might make suggestions based on the first few characters the user enters into the query field. Doing so saves the user the cumbersome task of manually typing each query in its entirety. As will be described in detail below, in accordance with the present techniques, the typeahead feature in connected devices will be leveraged to facilitate use of the captured lists of items. In this manner the participants will not have to recreate the lists themselves whenever they want to use to information, it will be done for them in an automated manner. For instance, again using the exemplary scenario where the speaker recites an address, the present system 200 will use voice recognition to actively capture voice data from the speaker and derive the (spoken) address as text. That derived text is then stored in memory to enable typeahead of the address. Thus, when any of the participants/users later needs to input the address information into the fields of, e.g., a web-based mapping service, typeahead suggestions can be provided which the participant/user can accept to automatically populate the fields. Doing so advantageously provides a more efficient way for users to input information. For example, the typeahead feature can present autosuggest text to the user on a display or other user interface of the user's device. In one exemplary embodiment, the present typeahead feature can be initiated whenever the participant/user begins typing items contained in the memory (and which correspond to the saved lists of items). As will be described in detail below, the derived text can be instantiated in the memories of the participants' devices, e.g., the participants' computers, mobile devices such as smartphones, etc. However, storing the derived text locally with the end-user is not a requirement, and embodiments are also contemplated herein where system 200 includes a central database or other repository for storing the lists of items, which can be implemented by system 200 to generate typeahead in the devices of one or more of the users.

As will be described in detail below, system 200 can also employ natural language processing to contextualize the captured data into predefined categories. For instance, system 200 can recognize the derived text as being addresses, telephone numbers and/or connected lists of items. Further, embodiments are contemplated herein where system 200 also provides a suggested application and automatically distributes the typeahead text to that suggested application. For instance, when a user wants directions for an address on the list, the present system 200 can also suggest a particular mapping application and autocomplete the address fields with the derived text. The user then simply has to review and submit the query to obtain the results.

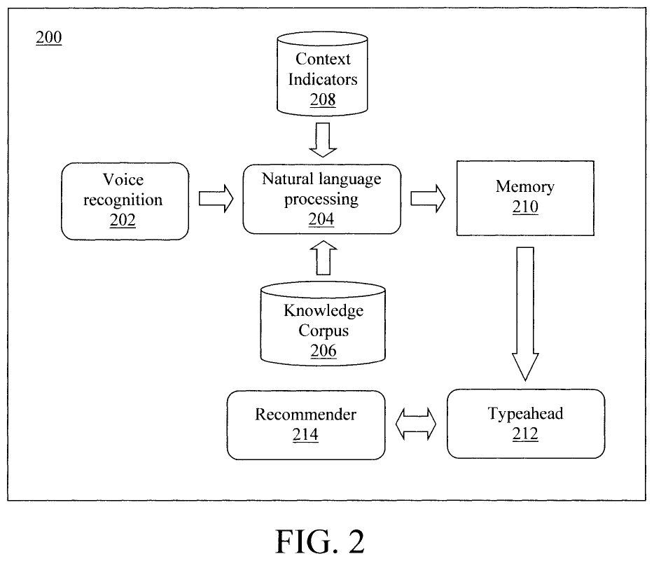

Specifically, referring to FIG. 2, an exemplary configuration of system 200 is provided. According to the exemplary embodiment shown in FIG. 2, system 200 includes at least a voice recognition module 202, a natural language processing module 204, a memory 210, a typeahead module 208 and a recommender 210. Rather than taking a passive role, voice recognition module 202 enables system 200 to actively capture voice data during a web-based call such as a Voice Over Internet Protocol (VOIP) connection, and derive text using its voice to text capabilities. The phrase “Voice Over Internet Protocol.” as used herein generally refers to any technology that provides voice communications over Internet Protocol networks such as the internet. State of the art voice recognition (also known as speech recognition) uses artificial intelligence and machine learning to identify, understand and process voice data including human speech. Among the capabilities of most voice recognition technology is the ability to translate speech/voice data to text data, i.e., voice to text. Thus, through voice to text, voice recognition module 202 captures what a speaker or speakers is/are saying during the web-based call and from that speech/voice data derives text data (also referred to herein as ‘derived text’).

In one exemplary, non-limiting example, voice recognition module 202 employs a neural network such as Long Short-Term Memory (LSTM). LSTM is a recurrent neural network having feedback connections which enables it to process sequences of data like voice data, making it an ideal tool for voice recognition. LSTM can be embodied in a neural network (such as neural network 600 of FIG. 6—described below), having an input layer, a hidden layer, and an output layer, with the hidden layer containing memory cells and corresponding gate units.

Of particular interest are the lists of items a speaker may mention during the call, such as addresses, telephone numbers, lists of numbered items, etc. Thus, in accordance with the present techniques, the term ‘list’ as used herein generally refers to any meaningful grouping or sequence of ordered items, all belonging to a common category. Thus, for example, if a telephone number is made up of three numbers/hyphen/three numbers/hyphen/four numbers, then a grouping of items that each follows that convention may be considered as a list of telephone numbers. Similarly, if an address is made up a street/city or town/state/zip code, then a grouping of items that each follows that particular convention may be considered as a list of addresses, and so on.

To specifically enable the identification and capturing of lists of items from the speech data, system 200 employs natural language processing module 204. Natural language processing (or NLP) is a machine-learning technique by which computers interpret and manipulate human language in the form of text and/or voice data. Natural language processing combines computational linguistics (i.e., rule-based modeling of human language) with statistical, machine learning, and deep learning models in order to understand the full meaning of the data including the author's/speaker's intent. To do so, the input data can be separated into fragments enabling the grammatical structure of sentences and the meaning of words to be analyzed and understood in their present context.

It is notable that, while natural language processing module 204 is depicted in FIG. 2 as being distinct from voice recognition module 202, this is done merely to highlight the individual capabilities of system 200. Namely, embodiments are contemplated herein where natural language processing is one of the capabilities leveraged by voice recognition module 202 to understand and process the input voice data from the speaker(s).

Thus, according to an exemplary embodiment, natural language processing module 204 processes the derived (voice to text) data from voice recognition module 202 to identify lists of items in the data anytime words arranged in a specific format are detected, e.g., a group or sequence of ordered items that belong to a common category. For instance, as provided above, a sequence of items having the format three numbers/hyphen/three numbers/hyphen/four numbers may be identified by natural language processing module 204 as a telephone number. A sequence of items having the format street/city or town/state/zip code may be identified by natural language processing module 204 as an address. Additional examples include, for example, an ordered sequence of items having the format first, second, third, etc., or step 1, step 2, step 3, etc. which natural language processing module 204 may identify as an ordered list of connected items.

Embodiments are also contemplated herein where, in addition to identifying lists of items in the derived text from voice recognition module 202, natural language processing module 204 further classifies the lists of items into different predefined groups or categories. For instance, natural language processing can employ text classifiers to automatically analyze the derived text and assign a predefined category (or categories) to the analyzed text based on its content. These text classifiers are trained on past/historical data such as that contained in a knowledge corpus (see below). In accordance with the present techniques, some exemplary predefined categories include, but are not limited to, telephone numbers, addresses, ordered lists, etc. (see the specific examples provided above). Advantageously, classifying the lists of items facilitates the subsequent typeahead feature. Namely, as will be described in detail below, the lists of items in a given category can automatically be distributed to the same suggested application (e.g., all derived lists of items that fall into the predefined category ‘Addresses’ can be distributed to the same web-based mapping service), rather than individually evaluating each list each time it is called up by a user.

To further facilitate the identification and classification process, voice recognition module 202 and natural language processing module 204 may also be used to capture the context of the conversation (i.e., between speaker and participant(s)). For instance, phrases such as ‘Write this down’ or ‘Here is the list’ can be leveraged to identify and/or categorize the associated text as a list of items. To use an illustrative, non-limiting example, say for instance that the speaker says “The following is the list of telephone numbers: [Telephone Number 1], [Telephone Number 2] and [Telephone Number 3].” Natural language processing module 204 can leverage this phrase that precedes the items. i.e., [Telephone Number 1]. [Telephone Number 2] and [Telephone Number 3] to a) identify the items as belonging to a list and b) categorize the items as telephone numbers.

This process of contextualizing and classifying the derived text can leverage a knowledge corpus 206 (e.g., a text database) and/or a repository 208 of context indicators. For instance, the knowledge corpus 206 can provide annotated/labeled historical text data that is used to train the text classifiers. For tasks such as text classification, it is notable that labeling of the text data is needed. When text is encountered that is not in the knowledge corpus 206, the repository 208 of context indicators can be used to annotate the text. The term ‘context indicators’ as used herein generally refers to any information that contextualizes an item relative to its content, such as an annotation or label given to text data. These context indicators can be obtained using any commercially-available annotation tool and/or from an open-source library.

Furthermore, embodiments are also contemplated herein where natural language processing module 204 detects contextual patterns and/or priority in the derived text. For instance, a conversation about a particular topic might list items out of order, however the speaker explains the priority of the items as the speaker goes through them. For instance, in a conversation about the location of a business, the speaker might mention something like “You can't miss it, it's the biggest building in Springfield” but then goes on to provide the exact address starting with the street number. In that case, natural language processing module 204 can detect the contextual patterns in the transcribed text, recognize that an address is being given and provide the respective items in the correct order for an address format.

As shown in FIG. 2, the list of (text) items identified (and preferably classified/categorized) by natural language processing module 204 are then stored in a memory 210. In one exemplary embodiment, memory 210 is present in one or more connected devices. For instance, participants to the conversation access the Voice Over Internet Protocol connection via their respective devices, i.e., computers, mobile devices such as smartphones, etc. For those users who opt in, instantiating the captured lists in the memory of these users' devices enables a subsequent typeahead feature, e.g., whenever a user begins to type (or otherwise input) items in the recognized list on their connected device (see below). However, storing the recognized lists in the memory of end-user devices is only one possible implementation contemplated herein. For instance, memory 210 may instead be a cache associated with system 200 and can be representative of any of the data stores shown in FIG. 1, including, but not limited to, volatile memory 112, persistent storage 113 and/or cache 121. Again, for users that opt in to the present typeahead features, system 200 can then detect whenever any of those users is typing the items and autocomplete the list for that user. System 200 can also go a step further by providing a suggested application for the list, and then auto-populating the field(s) in that suggested application with the derived text. For instance, if a user begins typing an ordered list of the items given by the speaker, system 200 can suggest a note taking application and automatically populate its fields with the list on the user's device. This avoids the tedious task of having to re-type the complete list word for word.

Thus, the present typeahead feature can be triggered whenever system 200 detects that a user is typing items contained in memory 210. For instance, according to an exemplary embodiment, system 200 can detect multiple consecutive characters inputted by the user that are contained within strings (e.g., sequences of characters) located in memory 210 and autosuggest the stored relevant text, preferably in an application suggested by system 200.

Namely, typeahead module 212 can monitor activity on the connected devices, and recognize when a respective user of one of these devices is typing items that coincide with the text stored in memory 210. Typeahead module 212 will then auto-populate the list on the user's device. For instance, when typeahead module 212 detects that the user is typing multiple consecutive characters that coincide with list items stored in memory 210, typeahead module 212 triggers the typeahead feature for these items. Optionally, typeahead module 212 may employ a user interface that displays the typeahead suggested text such as by way of a caption or other feature on the user's screen. By way of this interface, the user can opt in or otherwise reject the suggestion being made by system 200 to autocomplete the fields.

As highlighted above, typeahead module 212 can work in concert with a recommender 214 which, in addition to making typeahead suggestions, may also suggest an application for the user that is appropriate for the items in the autocompleted list. For example, if the user begins typing consecutive characters on the user's smartphone or computer from a list of direction items contained in memory 210, recommender 214 can recommend a publicly-available web-based mapping application, and typeahead module 212 can auto-populate the fields of that mapping application's search function. As highlighted above, system 200 can optionally display the typeahead suggestions in a caption or other interface on the user's device, allowing the user to accept, reject or even edit the suggested text. Advantageously, by way of this process, the user merely has to type (or otherwise input) the first few characters of the address to receive a fully completed search result in an appropriate mapping application. As illustrated by the examples provided below, the same technique can be applied to lists of items in a wide variety of applications such as, but not limited to, note taking applications, etc.

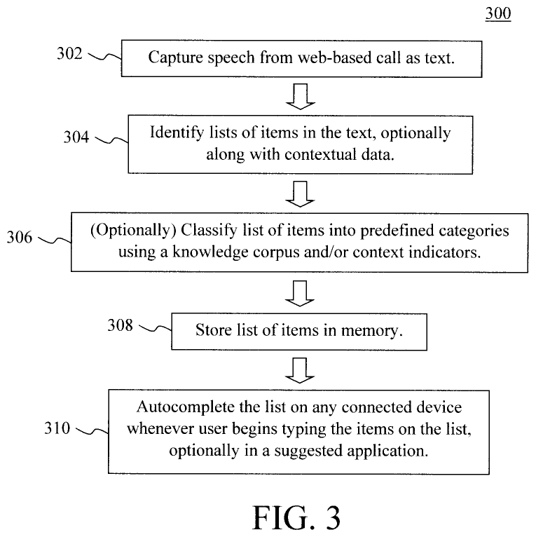

FIG. 3 is a diagram illustrating an exemplary methodology 300 for providing typeahead suggestions performed, for example, by system 200 above. In step 302, voice recognition is used to capture what a speaker or speakers is/are saying during a web-based call and from that speech/voice data derive text using, for example, the voice to text capabilities of voice recognition module 202. According to an exemplary embodiment, the web-based call is carried out over a Voice Over Internet Protocol (VOIP) connection.

As provided above, of particular interest in the present techniques are the lists of items a speaker may mention during the call, such as lists of addresses, telephone numbers, numbered/ordered items, etc. Thus, in step 304, lists of items are identified in the derived text using natural language processing. For instance, according to an exemplary embodiment, the natural language processing module 204 of system 200 is used to detect words arranged in a specific format such as a group or sequence of ordered items that belong to a common category like a sequence of items having the format three numbers/hyphen/three numbers/hyphen/four numbers which natural language processing module 204 might identify as a telephone number, or a sequence of items having the format street/city or town/state/zip code natural language processing module 204 might identify as a list of addresses.

Embodiments are also contemplated herein where, in addition to identifying lists of items, natural language processing module 204 also captures contextual data from the derived text. The term ‘contextual data’ as used herein generally refers to any elements of the derived text that help capture the context of the conversation. For instance, the speaker might identify items as being part of a list by saying something like ‘write this list of steps down.’ While not part of the list itself, this contextual data helps identify the items that follow as a list of steps.

Optionally, in step 306, the lists of items identified in the derived text are further classified into different predefined categories. For instance, according to an exemplary embodiment, natural language processing module 204 is configured to use text classifiers to analyze the lists of items and automatically assign them to a predefined category (or multiple predefined categories as the case may be) based on the content of the lists. The text classifiers can use machine learning or semantically-relevant elements of the text to classify the lists into one or more of the predefined categories. For instance, by way of example only, the predefined categories might include, but are not limited to, telephone numbers, addresses, ordered lists, etc. Categorizing the lists facilitates typeahead into the appropriate suggested application. Namely, the suggested application can be selected based on what predefined category a given list of items is classified in. For instance, all lists categorized as addresses can be distributed to a common web-based mapping application.

As highlighted above, natural language processing module 204 can use text classifiers trained using labeled data from the knowledge corpus 206. The training data can be supplemented with context indicators from the repository 208 when elements are encountered that are not already in the knowledge corpus 206. These context indicators can be obtained using any commercially-available annotation tool and/or from an open-source library.

In step 308, the lists of items from step 304 (preferably classified/categorized in step 306) are then stored in memory 210. According to an exemplary embodiment, memory 210 represents the memory present in the connected devices, i.e., computers, mobile devices such as smartphones, etc., of the participants in the web-based call that opt in to the present typeahead features. In that case, step 308 involves instantiating the lists of items 304 in the memory of each of those participating devices. Doing so will enable typeahead to be implemented whenever the respective user begins to type (or otherwise input) items in the recognized list (see below). However, embodiments are also contemplated herein where system 200 employs its own cache (e.g., volatile memory 112, persistent storage 113 and/or cache 121 in FIG. 1) to store the lists of items. System 200 can then detect when any of the connected users that opts in to the present typeahead features begins typing the items on their respective devices, and autocomplete the list for that user.

Namely, in step 310, the list of items is autocompleted from the memory 210 (via a typeahead feature) on any of the participating connected devices whenever the respective user begins typing the list. For example, if an address is stored in memory 210, and one of the connected users begins typing the first few characters, e.g., ‘123 Map1’ into a web-based mapping application, then typeahead module 212 will detect that the user is recalling one of the lists of items, retrieve that list from memory 210, and autocomplete the remaining fields of the web-based mapping application, e.g., with ‘123 Maple Street, Anytown, NY’. According to an exemplary embodiment, the typeahead feature is activated when typeahead module 212 detects multiple consecutive characters inputted by the user (e.g., by detecting keystrokes) that are contained within strings located in memory 210. As highlighted above, system 200 can optionally present the user with the typeahead suggested text in a caption or other similar user interface on the user's screen which appears, for example, next to the field which will be auto-populated. The user can then be given the option to either accept or reject the suggestions being made by system 200 to autocomplete the fields.

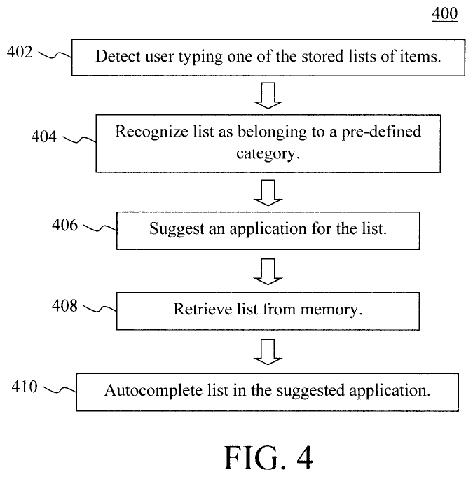

Preferably, this typeahead suggestion in step 310 is auto-populated in an application that system 200 also suggests to the user on the user's connected device. For example, reference is now made to FIG. 4 which provides one exemplary way for carrying out step 310 of methodology 300. For instance, according to methodology 400 of FIG. 4, whenever a user begins typing one of the items stored in memory 210, such as when the user types (or otherwise inputs) ‘123 Map1’ in a web browser, in step 402 system 200 detects that the user is typing one of the stored lists of items. In step 404, system 200 will also recognize that this list has been classified into a predefined category, in this case “address” (see description of step 306, above). In step 406, recommender 214 suggests an appropriate application for the retrieved data. For example, if the list in question belongs to the predefined category of addresses, then the recommender 214 can suggest a web-based mapping application to the user. According to an exemplary embodiment, the recommender 214 suggests the same application for each of the lists falling under the same predefined category, e.g., all addresses go to the same web-based mapping application. In step 408, the list that the user has begun typing is retrieved from the memory 210. In step 410, typeahead module 212 then autocompletes the list in the suggested application. It is notable that, while it is a time-saving benefit to the user, selecting the application for typeahead is not a requirement, and embodiments are contemplated herein where the typeahead feature is implemented in an application chosen by the user.

As described above, the captured lists of items can be instantiated in the memory of each of the connected devices that opts in to the present typeahead features. In that case, each participating device will receive and store in its memory the lists of items that were identified from text captured from speech from a web-based call as per steps 302 and 304 of methodology 300 described above, and which have been optionally classified into one or more predefined categories as per step 306 of methodology 300 described above. Whenever the respective user of the device begins typing (or in some other way inputting) items on the list (e.g., the user types multiple consecutive characters that are contained within strings located in the device's memory), the device will autocomplete the fields (preferably in a suggested application) using the list retrieved from memory as per step 310 of methodology 300 described above.

Alternatively, in the case where system 200 employs its own cache to store the lists of items (obtained as per steps 302-306 of methodology 300 described above), then system 200 can monitor activity on the participating devices. Whenever system 200 detects that a respective one of the users is beginning to type (or in another way input) items on the list (e.g., the user types multiple consecutive characters that are contained within strings located in the device's memory), then system 200 will autocomplete the fields (preferably in a suggested application) using the list retrieved from memory as per step 310 of methodology 300 described above.

The present techniques are further illustrated by way of reference to the following non-limiting use case examples. Use Case—Example #1: User A is talking to User B over a Voice Over Internet Protocol (VOIP) connection. User B is telling User A the address and telephone number of a client. The device of User A instantiates the text in its memory. If the present system detects User A beginning to type the address, the autosuggest offers User A a complete address typeahead and opens the most applicable application to auto-populate the data in.

Use Case—Example #2: User A is listening and taking notes in User B's virtual presentation about learning how to code in a particular computer programming language. User B describes a list of dependencies to setup, learn and then finally run a program. The present system 200 recognizes the items as a list, since User B is numbering them as he talks through the topics. System 200 then detects that User A is beginning to type items (the numbered list) in the recognized list and offers typeahead containing the complete list within User A's note taking application. For example, in this scenario, system 200 might generate the following typeahead sample,

### Coding Steps for Starters:

Step 1: Data types and variables
Step 2: Conditional statements
Step 3: Functions
Step 4: Loops
Step 5: Data structures

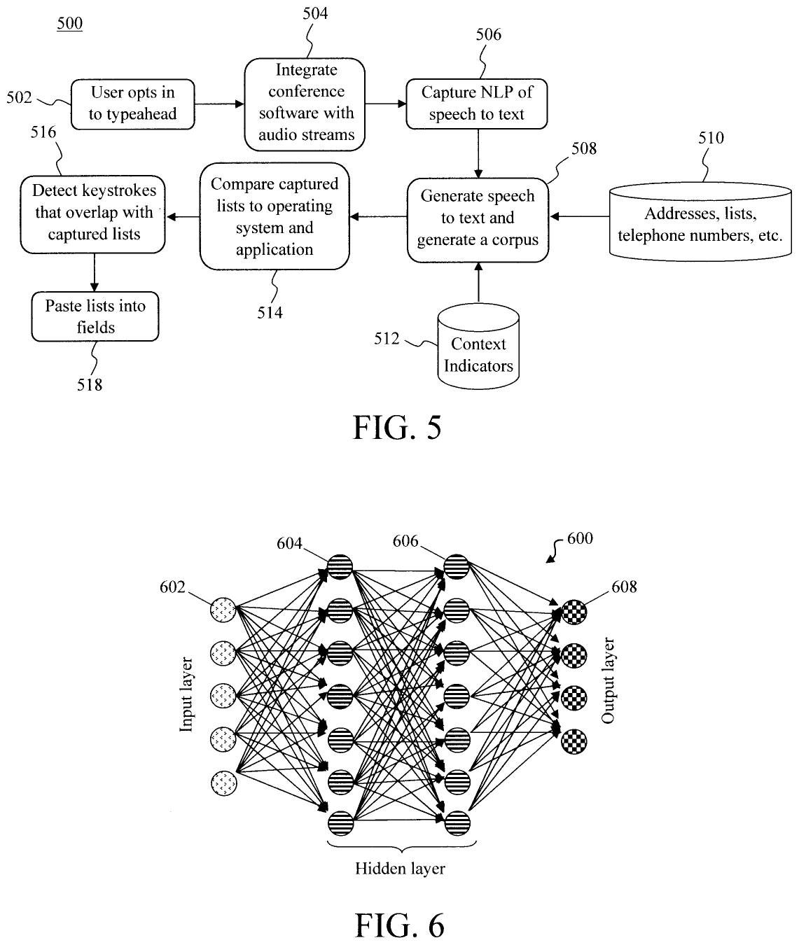

Methodology 500 of FIG. 5 provides another exemplary implementation of the present techniques. Referring to methodology 500, in step 502 the users/participants to a web-based conference call are given the option to opt in to the present voice to text generated typeahead feature. In step 504, the conference call software integrates with audio streams and the operating system of the participating users, i.e., those that have opted in. In step 506, the present system 200 captures natural language processing (NLP) of speech to text of the words the audience mentions.

In step 508, speech to text is generated and a corpus is created anytime items in a specific format (namely that of a list) are detected. In the same manner as described in detail above, these identified lists of items can further be classified into one or more predefined categories such as addresses, lists, telephone numbers, etc. leveraging a knowledge corpus 510 and/or repository 512 of context indicators for the classification.

In step 514, the speech to text captured lists of items are compared to the users' operating systems and applications. In step 516, keystrokes or data entry fields are detected that overlap with the captured lists. As such, the present typeahead feature is employed where, in step 518, the (originally spoken) lists are pasted as text into the fields of the applicable application.

As provided above, the present system can employ LSTM for voice recognition. LSTM can be embodied in a neural network such as neural network 600 of FIG. 6. As shown in FIG. 6, neural network 600 includes a plurality of interconnected processor elements 602, 604/606 and 608 that form an input layer, at least one hidden layer, and an output layer, respectively, of the neural network 600. The connections in neural networks that carry electronic messages between simulated neurons are provided with numeric weights that correspond to the strength or weakness of a given connection. These numeric weights can be adjusted and tuned based on experience, making neural networks adaptive to inputs and capable of learning. Typically, neural networks are trained on labeled sets of training data. Once trained, the neural network can be used for inference. Inference applies knowledge from a trained neural network model and uses it to infer a result. A fully connected layer (typically the last or last few layers in a neural network) is a layer where all of the inputs from one layer are connected to every activation unit of the next layer. The fully connected layer(s) compile the data extracted by previous layers of the neural network to form the final output.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for providing typeahead, the method comprising:
identifying lists of items captured as text from voice data on a Voice Over Internet Protocol connection using voice recognition and natural language processing; and
storing the lists of items in memory thereby enabling the typeahead of the lists of items on one or more electronic devices.

2. The method of claim 1, further comprising:
retrieving the lists of items from the memory; and
autocompleting the lists of items on the one or more electronic devices whenever items from the lists of items are being inputted into the one or more electronic devices.

3. The method of claim 2, further comprising:
autocompleting the lists of items on the one or more electronic devices whenever multiple consecutive characters are being inputted that are contained within strings located in the memory.

4. The method of claim 1, further comprising:
displaying, on a user interface, typeahead suggestions that will be used to autocomplete the lists of items.

5. The method of claim 1, further comprising:
providing a suggested application; and
autocompleting the lists of items on the one or more electronic devices in the suggested application.

6. The method of claim 5, further comprising:
classifying the lists of items into predefined categories.

7. The method of claim 6, wherein the predefined categories are selected from the group consisting of: addresses, telephone numbers, connected lists of items, and combinations thereof.

8. The method of claim 6, wherein the lists of items are classified into the predefined categories using a knowledge corpus and context indicators.

9. The method of claim 6, further comprising:
selecting the suggested application based on the predefined categories in which the lists of items are classified.

10. The method of claim 1, wherein the memory is present in the one or more electronic devices.

11. A system for providing typeahead comprising a processor, connected to a memory, operable to perform:
identifying lists of items captured as text from voice data on a Voice Over Internet Protocol connection using voice recognition and natural language processing; and
storing the lists of items in the memory thereby enabling the typeahead of the lists of items on one or more electronic devices.

12. The system of claim 11, wherein the processor is further operable to perform:
retrieving the lists of items from the memory; and
autocompleting the lists of items on the one or more electronic devices whenever items from the lists of items are being inputted into the one or more electronic devices.

13. The system of claim 12, wherein the processor is further operable to perform:
autocompleting the lists of items on the one or more electronic devices whenever multiple consecutive characters are being inputted that are contained within strings located in the memory.

14. The system of claim 11, wherein the processor is further operable to perform:
displaying, on a user interface, typeahead suggestions that will be used to autocomplete the lists of items.

15. The system of claim 11, wherein the processor is further operable to perform:
providing a suggested application; and
autocompleting the lists of items on the one or more electronic devices in the suggested application.

16. The system of claim 15, wherein the processor is further operable to perform:
classifying the lists of items into predefined categories.

17. A computer program product for providing typeahead, the computer program product comprising a computer readable storage medium having program instructions embodied therewith, the program instructions executable by a computer to cause the computer to perform:
identifying lists of items captured as text from voice data on a Voice Over Internet Protocol connection using voice recognition and natural language processing; and
storing the lists of items in memory thereby enabling the typeahead of the lists of items on one or more electronic devices.

18. The computer program product of claim 17, wherein the program instructions further cause the computer to perform:
retrieving the lists of items from the memory; and
autocompleting the lists of items on the one or more electronic devices whenever items from the lists of items are being inputted into the one or more electronic devices.

19. The computer program product of claim 18, wherein the program instructions further cause the computer to perform:
autocompleting the lists of items on the one or more electronic devices whenever multiple consecutive characters are being inputted that are contained within strings located in the memory.

20. The computer program product of claim 17, wherein the program instructions further cause the computer to perform:
providing a suggested application; and
autocompleting the lists of items on the one or more electronic devices in the suggested application.
